(19) United States
(12) Patent Application Publication
(10) Pub. No.: US 2002/0082030 A1
(43) Pub. Date: Jun. 27, 2002

(54) Apparatus and method for forwarding messages to terminals of various communication media

(76) Inventors: Stefan Berndt, Unna-Hemmere (DE); Bruno Bozionek, Borchen (DE); Hans-Juergen Hauschild, Paderborn (DE); Bernd Hinz, Rhda-Wiedenbrueck (DE); Uwe Langer, Paderborn (DE); Manfred Schuetz, Schlangen (DE); Volkmar Bilke, Salzkotten (DE); Meint-Uden Carstensen, Paderborn (DE); Dieter Hemkemeyer, Oelde (DE); Heinz Koopmann, Paderborn (DE); Wolfgang Pusch, Bueren (DE); Rainer Zimmermann, Paderborn (DE)

Correspondence Address: Bell, Boyd & Lloyd LLC, P.O. Box 1135, Chicago, IL, 60690, US

(21) Appl. No.: 09/997,681

(22) Filed: Nov. 28, 2001

(30) Foreign Application Priority Data
Nov. 29, 2000 (DE) 100 59 327.5

(51) Int. Cl. H04Q 7/20

(52) U.S. Cl. 455/466; 455/412

(57) ABSTRACT

A telecommunication device, and associated method, for forwarding messages intended for forwarded-to subscribers, including a database which contains subscriber-related information relating to a number of forwarded-to subscribers and terminals associated with these and message formats compatible with these terminals, and a control device. On reception of a message for a forwarded-to subscriber, the control device selects via the subscriber-related information one or more terminals via which the forwarded-to subscriber can be reached, and message formats which are compatible with these terminals, converts the message with the aid of conversion modules and forwards it to the respective corresponding telecommunication network interface for transmission to the selected terminals.

### BACKGROUND OF THE INVENTION

The present invention relates to an apparatus for forwarding messages which are intended for forwarded-to subscribers in each case associated with terminals in at least one telecommunication network. The apparatus includes a control device, a database with subscriber-related information and at least one telecommunication network interface via which messages can be exchanged with terminals of the forwarded-to subscribers and other subscribers of the at least one telecommunication network. The present invention similarly relates to a method for forwarding a message which is intended for a forwarded-to subscriber.

An information and communication path to a telecommunication subscriber is tied to different terminals and, thus, to different call addresses and transmission types in dependence on his/her location and the type of telecommunication medium currently selected by him/her or available to him/her. Another subscriber who would like to reach this subscriber (forwarded-to subscriber) independently of these circumstances, for example in order to convey a message to him/her, is, therefore, frequently faced with the task of guessing the currently applicable call address of the forwarded-to subscriber. Possible types of transmission are, for example, landline telephones, mobile telephones, telefax, short message services (SMS) (where the call addresses are usually call numbers) or electronic message services (so-called e-mail services) where the addressing is done via alphanumeric e-mail addresses. For the other subscriber who intends to establish a connection to the forwarded-to subscriber or to establish contact with him/her, respectively, it is, therefore, frequently necessary to know all possible call addresses and types of media of the forwarded-to subscriber, possibly also with additional information on the time at which of the call addresses should be successful.

A known approach to a solution uses call diversions; for example, in such a manner that the forwarded-to subscriber, in each case, programs a diversion to his current location. Apart from the fact that this is usually associated with some effort and, thus, becomes troublesome to the relevant forwarded-to subscriber, call diversion is only possible between terminals of the same type of media.

A similar problem, namely the administration of the availability of a non-localized subscriber, is known in the context of a cellular mobile radio system in which the total area over which the network is operated is divided into radio cells. It is then a task of the network to administer, for each of the network subscribers, the radio cell in which he/she is currently located. In a GSM network, a so-called home location register (HLR) is provided for this purpose which stores in a database all information significant for each mobile radio subscriber such as, e.g., call number, device identification (IMSI) and authentication key including dynamic subscriber data. The dynamic subscriber data are of a temporary nature and contain, for example, the current location area (LA) and a network-internal address of the responsible mobile switching center; i.e., the mobile radio switching center whose area of responsibility includes the location area in which the relevant subscriber is currently located. The responsible mobile switching center contains in a visitor location register (VLR) a set of subscriber data which are needed for setting up and maintaining the connection of the mobile subscribers, for the mobile subscribers located in the area of responsibility. When a subscriber changes into another location area, the associated subscriber data of the visitor location register of the mobile switching centers affected and of the home location register, are correspondingly updated.

However, the administration of availability used in a mobile radio network is based on the fact that, although the mobile subscribers are non-localized, they are always available via, in each case, a particular mobile. The type of mobile is known and cannot be changed. The use of different terminals, possibly of different type, which entails a considerable additional expenditure on the protocols used for this, is not provided in a mobile radio network.

It is an object of the present invention, therefore, to improve the availability of a subscriber when changing between a number of terminals which can be of different types. In particular, it should be possible to allow availability both via stationary and via mobile terminals depending on the subscriber's choice.

### SUMMARY OF THE INVENTION

Such object is achieved by an apparatus of the type initially mentioned, in which, according to the present invention, a database contains subscriber-related information which relates to a number of forwarded-to subscribers and terminals associated with the forwarded-to subscribers in at least one telecommunication network and to message formats compatible with these terminals. At least one conversion module is provided for converting temporarily stored messages into one or more of the message formats specified in the database, a control device being set up for selecting, on reception of a message intended for a forwarded-to subscriber, at least one terminal via which the forwarded-to subscriber can be reached, and at least one message format compatible with this terminal (or with, in each case, one of these terminals), via the subscriber-related information, supplying the message to the conversion module, respectively, for conversion in dependence on the message format thus selected. The control device accepts messages converted by this module and forwards them to the telecommunication network interface in each case corresponding to the relevant message format for transmission to the at least one selected terminal.

Similarly, the object set is achieved by a method of the type initially mentioned in which, according to the present invention, the following steps are carried out by the apparatus:

a) receiving the message;

b) selecting at least one terminal via which the forwarded-to subscriber can be reached, and at least one message format, which is compatible with this terminal (or with, in each case one of these terminals, respectively), via the subscriber-related information stored in the database;

c) converting the temporarily stored message into the at least one selected message format;

d) transmitting the converted message to the at least one selected terminal via a telecommunication network in each case corresponding to the relevant message format.

The present invention achieves the object set in a simple and comprehensive manner. The apparatus according to the present invention allows different communication technologies to be linked in order to conduct the information flow via different media to the location at which the subscriber is currently located.

Additional features and advantages of the present invention are described in, and will be apparent from, the following Detailed Description of the Invention and the Figures.

### BRIEF DESCRIPTION OF THE FIGURES

FIG. 1 shows a block diagram for the diagrammatic representation of a telecommunication network with a communication server according to the exemplary embodiment of the present invention.

FIG. 2 shows a block diagram for diagrammatically representing the communication server.

FIG. 2a shows a section from a subscriber database of the communication server.

### DETAILED DESCRIPTION OF THE INVENTION

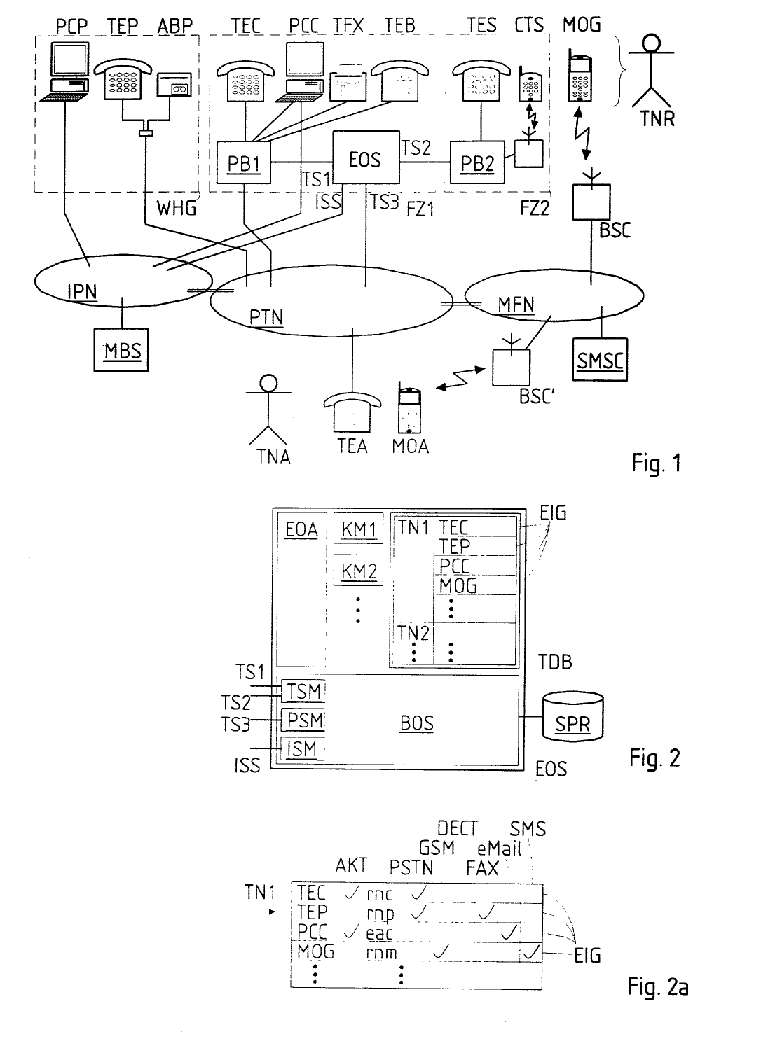

As already stated initially, it is frequently the case that a multiplicity of telecommunication terminals are associated with a subscriber. This is shown in FIG. 1 with the example of a subscriber TNR active in a company with two registered offices FZ1, FZ2, where the subscriber TNR represents a forwarded-to subscriber in the sense of the present invention in the exemplary embodiment considered here.

In a first registered office FZ1, for example, a telephone terminal TEC, a data processing device PCC (for example, a personal computer, PC in short) and another telephone terminal TEB at another location (e.g., in a common room or in a secretary's office) are available to the subscriber TNR at his/her office place. In addition, he/she uses a telefax device TFX at this office. In the exemplary embodiment shown, the devices TEC, TEB, TFX, which can be connected via a line-connected telephone network, are connected to a public landline network PTN via an in-house system PB1 (a so-called private branch exchange—PBX). In a variant, the in-house network also could be connected to a mobile radio network MFN (for example, a GSM network) in a familiar manner. The data processing device PCC can be connected to the so-called Internet IPN; for example, via a modem (not shown) or via a dedicated line.

In a second registered office FZ2 (for example, a laboratory) the subscriber TNR has a stationary telephone terminal TES and a cordless device CTS; e.g., according to the known DECT (digital enhanced cordless telecommunication) standard. These terminals TES, CTS are connected to the public telephone network via an in-house system PB2 of the site FZ2. In addition, the subscriber TNR has a mobile MOG with which he/she can be reached via the mobile radio network MFN. The mobile MOG also can be designed as a dual-mode mobile so that the subscriber can conduct conversations via the cordless interface of the in-house system PB2 in the area of the DECT system of the second registered office FZ2.

Furthermore, a landline connection is set up in an apartment WHG of the subscriber TNR, at which an answering machine ABP is connected, for example, in addition to a (private) telephone terminal TEP. In addition, a private data processing device PCP of the subscriber can be connected to the Internet IPN.

In FIG. 1, the various communication networks are only shown symbolically since the internal structure of these communication networks is of little significance to the present invention. For the sake of completeness, base stations BSC, BSC′ and a so-called SMSC (short message service center) for supporting the transmission of short messages are shown in the mobile radio network MFN and a server MBS (mailbox server), which provides the Internet subscribers, e.g., with so-called to electronic mailboxes for temporarily storing e-mail messages, is shown in the Internet IPN. The networks PTN, MFN, IPN are linked to one another in a familiar manner; for example, via so-called gateways.

In cases in which another subscriber TNA attempts to reach the forwarded-to subscriber TNR, e.g., via a landline telephone TEA associated with him/her, a mobile MOA or, e.g., e-mail, via the Internet IPN, this subscriber TNA usually does not know the current location of the forwarded-to subscriber TNR. Frequently, only one or a couple of the call numbers or destination addresses is/are known via which the forwarded-to subscriber TNR can be reached. A “telephone search” is cumbersome, frequently time-consuming and troublesome for both subscribers TNA, TNR involved. In addition, for example, it may occur that the forwarded-to subscriber TNR can be reached via a terminal of one type of communication, e.g., a landline telephone or a data processing device set up for processing e-mail messages, but the other subscriber TNA wishes to establish contact with him/her via a message of another type of communication; e.g., an SMS message.

According to the present invention, a telecommunication device is provided as communication server EOS for forwarding and converting messages which are exchanged between the forwarded-to subscriber TNR and other subscribers TNA. This device holds in a subscriber database TDB subscriber-related information which is ordered in user profiles in the form of entry groups TN1, TN2, . . . via the forwarded-to subscribers (where the subscriber TNR is to correspond to the first entry group TN1 here for the sake of simplicity). Each entry group contains entries EIG which, in each case, contain information on a telecommunication terminal TEC, TEP, PCC, MOG, . . . associated with the relevant subscriber; see FIG. 2a. This may be, for example, the call address rn, rnp, eac, rnm, . . . associated with the terminal (call number or destination address and, e.g., e-mail address), the associated types of communication or compatible message formats (landline network PSTN, GSM, DECT, telefax, e-mail, SMS etc.), e.g., in the form of a list in which the corresponding fields are activated, and other information if needed.

To perform the message forwarding, the communication server EOS has an application module EOA which, in the exemplary embodiment shown, is implemented as an application program installed on an operating system BOS. Furthermore, conversion modules KM1, KM2, . . ., e.g., supplementary routines which can be called up by the application EOA, are provided for converting messages between various types of communication or messages. In addition, a storage medium SPR is associated with the communication server EOS for temporarily storing messages and for permanently storing the subscriber database TDB. As an alternative, this storage medium also can be integrated in the communication server EOS.

The communication server EOS can be connected to the private networks PB1, PB2 and to the landline network PTN and the Internet IPN via telephone interfaces TS1, TS2, TS3 and a data network interface ISS. As an alternative, an additional link to a radio network MFN (not shown) would also be conceivable. The interfaces TS1, TS2, TS3, ISS are implemented by interface modules TSM, PSM, ISM associated with the operating system BOS, which are used for exchanging signaling information (e.g., for setting up and maintaining connections) and transmitting and receiving messages via these interfaces in a familiar manner.

According to the present invention, the communication server EOS, more precisely the application module EOA, is set up to select, on reception of a message intended for the forwarded-to subscriber TNR, one or more terminals via which the forwarded-to subscriber TNR can be reached and corresponding message formats, that is to say message formats which are compatible with the terminals, via the subscriber-related information of the database TDB. The selection is made, for example, via another element AKT (see FIG. 2a) which exists in the entries EIG associated with the relevant forwarded-to subscriber TNR and specifies which terminals messages can or should be currently sent to. As an alternative, more than one terminal of the forwarded-to subscriber TNR also can be activated in the associated user profile TN1. The message is then converted into the selected message format or formats. For this purpose, the application module EOA calls up the corresponding conversion modules KM1, KM2, transfers to them the messages to be converted and accepts the converted messages after completed conversion. It is advantageous in this context if the received and/or converted messages are temporarily stored for reasons of data protection. The messages are then sent to the selected terminals via the relevant interfaces.

Supplying the messages to the communication server EOS instead of supplying them to a terminal of the forwarded-to subscriber TNR can be implemented, for example, with the aid of call diversions. Using the information transferred with the call signaling, the application module EOA can find out which forwarded-to subscriber TNR was originally dialed by the calling subscriber TNA and can perform or initiate the further processing on the basis of the entry group TNI associated with this forwarded-to subscriber TNR.

Another possibility is to provide the subscriber TNA with the call address of the forwarded-to subscriber TNR in the form of a call address of the communication server EOS which is unambiguously allocated to the forwarded-to subscriber TNR or suitably contains additional information specifying the forwarded-to subscriber TNR. For example, the telephone number used can be a call number of the communication server EOS to which a subscriber-related identifier is appended as suffix (as in the case of a private branch exchange). In the case of e-mail addresses, a so-called e-mail domain can be reserved for the communication server EOS. The forwarded-to subscribers TNR are then associated, for example, with addresses in this domain in accordance with the arrangement “subscriber@serverdomain.”

The availability of the forwarded-to subscriber TNR is updated in the database TDB by appropriately changing the element AKT in the entries of the associated entry group TN1. This can be done, for example, by the forwarded-to subscriber TNR himself/herself calling the communication server EOS from one of his/her terminals, advantageously via a call address specifically set up for this purpose, or sending a message to it. This signals to the communication server EOS that the relevant terminal is to be activated; i.e., the element AKT of the associated entry is set. In the simplest case, the elements AKT of the remaining entries are reset. As an alternative, it can be provided that, if necessary, the remaining entries can be controlled via additional information; e.g., post-dialed digits or text commands in an e-mail message. Thus, for example, a particular addition can mean that the elements previously set are not reset, but another one can mean that all elements AKT of the relevant entry group TN1 are set. The latter possibility thus activates the delivery to all terminals of the forwarded to subscriber TNR.

In the text which follows, the treatment and conversion of messages according to the present invention are illustrated using some case examples.

E-mail to Telefax:

The subscriber TNA sends an e-mail message mentioning the forwarded-to subscriber TNR in the address list of this e-mail message, possibly in addition to other addressees. In an entry EIG of the subscriber database TDB, which is associated with the telefax device TFX, the element AKT is set. The e-mail message is delivered to the communication server EOS. The application program EOA then performs the conversion of the e-mail message into the telefax format in a familiar manner with the aid of a corresponding conversion module. The telefax message obtained in this manner is then sent to the telefax device TFX.

E-mail to SMS Message:

In addition to the previous case example, the mobile MOG of the forwarded-to subscriber TNR is activated with regard to the SMS entry. In this case, the conversion takes place in a familiar manner via a conversion module which is set up for converting e-mail messages into SMS messages. For the rest, this case example corresponds to the previous example.

The conversion of e-mail messages also can be initiated by the forwarded-to subscriber TNR; for example, if the e-mail messages are stored in an electronic mailbox MBS. This is done, for example, by the forwarded-to subscriber TNR calling from his/her mobile MOG a call number provided for this purpose and associated with the communication server EOS. In this case, the communication server EOS calls up the mailbox server MBS via the Internet IPN. Further processing is carried out as already described.

E-mail to Voice/Telephone:

As before, but the mobile MOG is only activated for voice messages, not for SMS messages. Instead of the conversion of the e-mail message to an SMS message, conversion into a voice message is performed with the aid of a so-called TTS (text-to-speech) converter. The same applies to delivery to a landline telephone.

Appointments File to Voice/Telephone:

This case example can be seen as a further development of the preceding case example. The forwarded-to subscriber TNR has, for example, an electronic appointments calendar in his/her data processing device PCC and wishes to interrogate the appointments contained in it via his/her private telephone TEP. Initiated by a call originating from his/her telephone TEP to a call number associated with the communication server EOS and provided for this purpose, the application module EOA starts an interrogation via the Internet IPN or another data network; e.g., a LAN network (not shown in FIG. 1). The application module EOA accepts from the electronic appointments calendar of the forwarded-to subscriber TNR the appointments which are available, e.g., in the form of text, and converts them into voice messages via a TTS converter. These can then be transferred to the private telephone TEP as already discussed above.

Telefax to E-mail:

The communication server EOS receives a telefax message which is intended for the forwarded-to subscriber TNR. The data processing device PCC is activated in the associated entry field TN1 of the subscriber database TDB. The fax is converted into an e-mail message by the application module EOA and sent to the data processing device PCC via the Internet IPN. Since a fax corresponds to pixel graphics, text contained in the fax is advantageously converted via an OCR (optical character recognition) module and inserted into the e-mail message as legible text. In addition, the entire fax is attached as a graphics file to the e-mail message as a so-called attachment. In this manner, image information present in the fax cannot get lost.

SMS Message to E-mail:

In this case example, the forwarded-to subscriber TNR wishes to call up and read the SMS messages stored for his/her mobile telephone MOG via his/her private data processing device PCP. One reason for this is, for example, that the subscriber does not wish to read the SMS messages on the small display of his/her mobile telephone MOG but, instead, comfortably on the screen of his/her private data processing device PCP.

This process is initiated by a call of the forwarded-to subscriber TNR originating from his/her mobile MOG to a call number of the communication server EOS provided for this purpose. The communication server EOS calls up the SMS messages of the forwarded-to subscriber TNR from the SMS station SMSC of the relevant mobile radio network MFN and converts them into e-mail messages with the aid of a conversion module for converting SMS messages. These are then sent to the private data processing device PCP or the associated electronic mailbox MBS of the forwarded-to subscriber TNR via the Internet interface ISS from the mailbox server MBS via the Internet IPN.

Voice/Telephone to E-mail:

The communication server EOS receives a voice message intended for the forwarded-to subscriber TNR; for example, via the landline network PTN. The data processing device PCC is activated in the associated user profile TN1 of the subscriber database TDB. The voice message is recorded in the form of an audio file in a known audio data format by the communication server EOS. An e-mail message directed to the data processing device PCC is generated, the audio file is attached to it as an attachment and the message thus obtained is sent to the data processing device PCC or, respectively, the electronic mailbox associated with the forwarded-to subscriber TNR via the Internet IPN.

In addition, the voice message can be converted via an ASR (automated speech recognition) module and inserted into the e-mail message as legible text.

Similarly, the forwarded-to subscriber TNR can interrogate messages which have been stored in his/her answering machine ABP. For this purpose, the forwarded to subscriber TNR sends an order message per e-mail message, for example from his/her data processing device PCP, to the communication server EOS, which order message contains a relevant instruction. The application module EOA then performs a remote interrogation of the answering machine ABP. The signaling for this is done in a familiar manner; for example, via DTMF signals. The voice messages played back by the answering machine ABP are accepted and processed further as already described.

Voice/Telephone to Appointments File:

Similar to the conversion of appointments data into a voice message, this case example can be considered as a further development of the conversion of a voice message into an e-mail message. Following the conversion of the appointment, passed on by telephone (e.g., via a call number of the communication server EOS provided especially for this purpose), into a text format as described above, the appointments message thus obtained is transferred to the electronic appointments calendar of the forwarded-to subscriber TNR where it is incorporated in the appointments administration.

Naturally, the case examples mentioned can also be combined. Thus, a combination of the conversion of telefax into an e-mail message and the conversion of an e-mail message into a voice message results in the treatment of telefax messages which are supplied to a telephone as voice messages.

The present invention can also be used for coupling an answering machine to an e-mail system. It is known that a forwarded-to subscriber TNR who is absent for a relatively long time (e.g., on leave) activates in his/her e-mail system an absence message in which, for example, the duration of and the reason for his/her absence are specified and which is sent back to the respective sender as a response to incoming e-mail messages. In addition, the forwarded-to subscriber TNR will change the announcement text of his/her answering machine ABP so that a caller is informed about the duration of and reason for his/her absence. To simplify this process so that the forwarded-to subscriber TNR needs to perform the entry only once instead of performing it separately in both systems, both systems are to be coupled with the aid of the present invention.

If the forwarded-to subscriber TNR generates and activates an absence message in his/her e-mail system, a message is simultaneously sent to the communication server EOS which contains the text of the absence message. The text is then converted into a voice message via TTS conversion and the application module EOA performs a remote interrogation of the answering machine ABP in which the previously valid announcement text of the answering machine ABP is played back and stored, and instead of which the voice message previously obtained is recorded as a new announcement text. When the forwarded-to subscriber TNR deactivates the absence message at a later time, the original announcement text is recorded again on the answering machine ABP in a corresponding manner. Naturally, a new text which was newly entered and TTS-converted by the forwarded-to subscriber TNR on deactivation of the absence message could also be recorded as new announcement instead of the original announcement text.

Furthermore, it can be provided that during the absence, messages for the forwarded-to subscriber TNR can be left in the manner of an answering machine ABP via the communication server EOS. The messages thus left can be recorded, on the other hand, on the answering machine ABP of the forwarded-to subscriber TNR. On the other hand, the voice messages can be converted into an e-mail format and temporarily stored by the communication server EOS as above in conjunction with the conversion of a voice message into an e-mail message. The user can then listen in a simple manner to the voice messages received after his/her absence or from the location of his/her absence (if e-mail access is available there).

The communication server EOS according to the present invention is also suitable for type-independent distribution of messages of the forwarded-to subscriber TNR to other subscribers TNA. If, for example, the forwarded-to subscriber TNR wishes to send a voice message to a receiver, and the message is to be supplied as an e-mail message by the receiver, the communication server EOS basically acts as described above in the case example “voice/telephone to e-mail”. The communication server EOS receives from the forwarded-to subscriber TNR the voice message which is recorded in the form of an audio file in a familiar audio data format by the communication server EOS. An e-mail message directed to the receiver is generated, the audio file is attached to it as an attachment and the message thus obtained is conducted to the receiver, or the associated electronic mailbox, via the Internet. In addition, the voice message can be converted via an ASR (automated speech recognition) module and inserted into the e-mail message as legible text. A similar procedure can also be adopted for other combinations of the message types of the message sent by the forwarded-to subscriber TNR, and the terminal at the receiver end, the details being obvious from what has been said above.

Although the present invention has been described with reference to specific embodiments, those of skill in the art will recognize that changes will be made thereto without departing from the spirit and scope of the invention as set forth in the hereafter appended claims.

1. A telecommunication device for forwarding messages intended for a forwarded-to subscriber, comprising:
a control device;
a database for storing subscriber-related information, the subscriber-related information identifying a plurality of forwarded-to subscribers and terminals associated with the plurality of forwarded-to subscribers and message formats compatible with the terminals;
at least one telecommunication network interface via which messages can be exchanged with telecommunication networks; and
at least one conversion module for converting temporarily stored messages into at least one of the message formats identified by the subscriber-related information and stored in the database;
wherein the control device selects, upon reception of a message intended for a forwarded-to subscriber, at least one of the terminals via which the forwarded-to subscriber can be reached, and at least one message format compatible with the at least one terminal, via the subscriber-related information, supplies the message to the at least one conversion module depending upon the message format selected and receives the messages converted by the at least one conversion module and forwards them to the telecommunication network interface respectively corresponding to the relevant message format for transmission to the at least one selected terminal.

2. A telecommunication device for forwarding messages intended for a forwarded-to subscriber as claimed in claim 1, further comprising:
a storage device for temporarily storing at least one of messages received via the at least one telecommunication interface and converted messages.

3. A telecommunication device for forwarding messages intended for a forwarded-to subscriber as claimed in claim 1, wherein the subscriber-related information of the database contains an information element which identifies the terminals to be selected.

4. A telecommunication device for forwarding messages intended for a forwarded-to subscriber as claimed in claim 3, wherein the control device changes the information element based on messages sent off by the relevant forwarded-to subscriber, which contain information relating to an availability of the forwarded-to subscriber.

5. A method for forwarding a message intended for a forwarded-to subscriber, effected via a telecommunication device, the method comprising the steps of:
receiving the message;
selecting at least one terminal via which the forwarded-to subscriber can be reached, and selecting at least one message format, which is compatible with the at least one terminal, via subscriber-related information;
converting a temporarily stored message into the at least one message format selected; and
transmitting the converted message to the at least one terminal selected via a telecommunication network respectively corresponding to the relevant message format.

6. A method for forwarding a message intended for a forwarded-to subscriber as claimed in claim 5, the method further comprising the step of:
storing, temporarily, the at least one message on a storage device in at least one of the step of receiving and the step of converting.

7. A method for forwarding a message intended for a forwarded-to subscriber as claimed in claim 5, wherein during the step of selecting, the selection is made based on an information element which is contained in the subscriber-related information and which identifies the terminals to be selected.
